(19) United States
(12) Patent Application Publication
(10) Pub. No.: US 2020/0309896 A1
(43) Pub. Date: Oct. 1, 2020

(54) INDOOR POSITIONING METHOD AND SYSTEM AND ELECTRONIC DEVICE

(71) Applicant: SHENZHEN INSTITUTES OF ADVANCED TECHNOLOGY, SHENZHEN (CN)

(72) Inventors: YUBIN ZHAO, SHENZHEN (CN); FANGMIN LI, SHEN ZHEN (CN); CHENGZHONG XU, SHENZHEN (CN)

(21) Appl. No.: 16/731,046

(22) Filed: Dec. 31, 2019

Related U.S. Application Data
(63) Continuation of application No. PCT/CN2019/124516, filed on Dec. 11, 2019.

(30) Foreign Application Priority Data
Mar. 26, 2019 (CN) 201910232716.7

(51) Int. Cl. G01S 5/14; G01S 5/02

(52) U.S. Cl. CPC G01S 5/14; G01S 5/0284

(57) ABSTRACT

This application relates to an indoor positioning method and system and an electronic device. The method includes: calculating distances between an unknown node and at least three known nodes; obtaining at least three square regions around the at least three known nodes by using the distances as radiuses, and obtaining a minimum overlapping region based on overlapping parts of the at least three square regions; reducing the minimum overlapping region in an equal proportion by using a geometric center of the minimum overlapping region as a center to obtain a new square region; calculating an optimal vertex location of the new square region through iteration; and forming a new smaller region around the optimal vertex location by using the optimal vertex location as a new central point, and using an optimal vertex location of the smaller region as an estimated location of the unknown node.

### TECHNICAL FIELD

This application relates to the field of indoor positioning technologies, and in particular, to an indoor positioning method and system and an electronic device.

### BACKGROUND

With emergence of the Internet of Things and development of intelligent terminals, people have increasing demands for positioning and navigation. According to surrey data of Nokia Corporation, people spend 87% to 90% of time indoors, 70% of mobile terminals are used indoors, and 80% of data connections are established indoors. In complex indoor environments such as an airport lobby, an exhibition hall, a warehouse, a supermarket, a library, an underground parking lot, and a mine, indoor location information of mobile terminals or holders of mobile terminals, facilities, and objects usually needs to be determined. Currently, there are quite comprehensive outdoor GPS and GSM positioning technologies, but the GPS and GSM positioning technologies cannot be applied to indoor environments due to limitations such as signal blocking by buildings, positioning time, positioning precision, and complex indoor environments.

Currently, solutions to indoor positioning technologies include an A-GPS positioning technology, an ultrasonic positioning technology, a Bluetooth technology, an infrared technology, a radio frequency identification technology, an ultra-wideband technology, a wireless local area network, an optical tracking and positioning technology, image analysis, beacon positioning, computer vision positioning, and the like. These indoor positioning technologies can be generally classified into several types: a GNSS technology (for example, a pseudolite), a wireless positioning technology (a wireless sensor, ultrasonic, infrared, or the like), another technology (computer vision, dead reckoning, or the like), a fusion positioning technology of the GNSS technology and the wireless positioning technology, and the like. Based on the foregoing technologies and different information required in a positioning process, indoor positioning algorithms can be classified into two types: a range-free (range-free) algorithm and a range-based (range-based) algorithm. Range-free positioning algorithms include a centroid algorithm, an APIT (approximate point-in-triangulation text) algorithm, a DV-Hop algorithm, and the like. Range-based positioning algorithms include a TOA algorithm (based on time of arrival), a TDOA algorithm (based on a time difference of arrival), an AOA algorithm (based on an angle of arrival), an RSSI algorithm (based on received signal strength), and the like.

Currently, the Bluetooth technology with low power consumption is widely applied to indoor positioning because the Bluetooth technology is convenient to implement and consumes less power. Based on application of the Bluetooth positioning technology, an RSSI-based positioning algorithm is usually used, where RSSI means a received signal strength indicator.

In a Min-Max positioning algorithm, distances (d₁, d₂, d₃, . . . , and dₙ between an unknown node and three or more known nodes are calculated by using received signal strength at the unknown node based on a signal propagation loss formula. Then, a square region is formed around each known node by using the known node as a center and each of the calculated distances d₁, d₂, d₃, . . . , and dₙ as a length. A side length of a square region around a known node Zⱼ is 2dⱼ, and a plurality of square regions can be formed for a plurality of known nodes. Finally, a minimum overlapping region of all square regions is obtained, in this case, a central location of the minimum overlapping region is considered as an estimated location of the unknown node. The Min-Max positioning algorithm is shown in FIG. 1, where the five-pointed star represents an actual location, the smaller dot represents the estimated location, and the larger dot represents the known node.

In an E-Min-Max positioning algorithm, a received signal strength indicator is first converted into a distance value by using a signal propagation loss formula. Same as that in the Min-Max algorithm, a minimum overlapping region is finally obtained. The difference is as follows: The E-Min-Max positioning algorithm considers that an estimated location of an unknown node is possibly any location in the minimum overlapping region instead of a central location in an overlapping region. Then, the E-Min-Max positioning algorithm assigns a weight kV, for each vertex of this region, where the weight indicates a similarity between coordinates of the unknown node and coordinates of the vertex, and the following four weight criteria are provided:

$$\{ \begin{matrix}{W}_{1} ( j ) = \frac{1}{{\sum }_{i = 1}^{n} \vert {D}_{i , j} - {d}_{i} \vert} \\ {W}_{2} ( j ) = \frac{1}{{\sum }_{i = 1}^{n} {( {D}_{i , j} - {d}_{i} )}^{2}} \\ {W}_{3} ( j ) = \frac{1}{{\sum }_{i = 1}^{n} \vert {M}_{i , j} - {d}_{i} \vert} \\ {W}_{4} ( j ) = \frac{1}{{\sum }_{i = 1}^{n} {D}_{i , j}^{2} - {d}_{i}^{2}}\end{matrix} , \qquad ( 1 )$$

where

D_{i,y} and M_{i,j} represent an Euclidean distance and a Manhattan distance between a known node i and a vertex j of the minimum overlapping region, respectively. Eventually, the E-Min-Max positioning algorithm considers the following location as the estimated location of the unknown node:

$$[ {p}^{x} , {p}^{y} ] = [ \frac{{\sum }_{j = 1}^{4} {W}_{a} ( j ) \cdot {x}_{j}}{{\sum }_{j = 1}^{4} {W}_{a} ( j )} , \frac{{\sum }_{j = 1}^{4} {W}_{a} ( j ) \cdot {y}_{j}}{{\sum }_{j = 1}^{4} {W}_{a} ( j )} ] \qquad ( 2 )$$

The Min-Max positioning algorithm is relatively sensitive to noise, has a relatively poor immunity to interference, and has a relatively large positioning error. The E-Min-Max positioning algorithm has a relatively large calculation amount and high algorithm complexity, and cannot well satisfy a timeliness requirement of indoor positioning. In addition, there is a limitation in both the Min-Max algorithm and the E-Min-Max positioning algorithm. To be specific, an estimated location of an unknown node is definitely within a finally determined minimum overlapping region, but an actual location of the unknown node usually deviates from the minimum overlapping region and is outside the region due to impact of noise.

In conclusion, a signal path loss in an indoor environment varies greatly with different indoor layouts, material structures, and building scales of different buildings. In addition, internal structures of the buildings cause signal reflection, diffraction, refraction, and scattering, and therefore a multipath effect is formed, and an amplitude, a phase, and a time of arrival at a receiver of a received signal are affected. Consequently, a signal loss is caused due to these factors, making positioning difficult.

### SUMMARY

This application provides an indoor positioning method and system and an electronic device, to at least to some extent resolve one of the foregoing technical problems in the prior art.

To resolve the foregoing problem, this application provides the following technical solutions:

An indoor positioning method includes the following steps:

step a: calculating distances between an unknown node and at least three known nodes based on a signal propagation loss formula;

step b: obtaining at least three square regions around the at least three known nodes by using the distances as radiuses, and obtaining a minimum overlapping region based on overlapping parts of the at least three square regions;

step c: reducing the minimum overlapping region in an equal proportion by using a geometric center of the minimum overlapping region as a center to obtain a new square region;

step d: calculating an optimal vertex location of the new square region through iteration according to an iterative least square method; and

step e: forming a new smaller region around the optimal vertex location by using the optimal vertex location as a new central point, and using an optimal vertex location of the smaller region as an estimated location of the unknown node.

The technical solution in this embodiment of this application further includes: the calculating distances between an unknown node and at least three known nodes based on a signal propagation loss formula in step a is specifically as follows:

$${P}_{L} ( d ) = {P}_{L} ( {d}_{0} ) + 10 n lg ( \frac{d}{{d}_{0}} ) + {X}_{0} ,$$

where

in the formula, d represents a distance between a transmit end and a receive end, d₀ represents a near-earth reference distance, P_{L}(d) represents a path loss from the transmit end to the distance d, n represents a path loss index, and X₀ represents Gaussian distribution noise whose average value is zero.

The technical solution in this embodiment of this application further includes: the obtaining at least three square regions around the at least three known nodes by using the distances as radiuses, and obtaining a minimum overlapping region based on overlapping parts of the at least three square regions in step b is specifically as follows:

A is defined as a node that makes {zⱼ^{x}+dⱼ}ⱼ₌₁^{N} smallest, in other words, (z_{A}^{x}, d_{A})=argmin(zⱼ^{x}+dⱼ)ⱼ₌₁^{N}, and A, B, C, and D are defined as follows:

$$\{ \begin{matrix}A \text{:} ( {z}_{A}^{x} , {d}_{A} ) = argmin {\{ {z}_{j}^{x} + {d}_{j} \}}_{j = 1}^{N} \\ B \text{:} ( {z}_{B}^{x} , {d}_{B} ) = argmax {\{ {z}_{j}^{x} - {d}_{j} \}}_{j = 1}^{N} \\ C \text{:} ( {z}_{C}^{y} , {d}_{C} ) = argmin {\{ {z}_{j}^{y} + {d}_{j} \}}_{j = 1}^{N} \\ D \text{:} ( {z}_{D}^{y} , {d}_{D} ) = argmax {\{ {z}_{j}^{y} - {d}_{j} \}}_{j = 1}^{N}\end{matrix} ,$$

where

A, B, C, and D are four vertexes of the minimum overlapping region.

The technical solution in this embodiment of this application further includes: the forming a new smaller region around the optimal vertex location by using the optimal vertex location as a new central point, and using an optimal vertex location of the smaller region as an estimated location of the unknown node in step e specifically includes: performing iteration to calculate the optimal vertex location of the new smaller region, determining whether a specified quantity of iterations is reached, and using an optimal vertex location in the last iteration process as the estimated location of the unknown node if the specified quantity of iterations is reached.

The technical solution in this embodiment of this application further includes: in step e, the new smaller region has a same size as the square region.

Another technical solution in an embodiment of this application is an indoor positioning system, including:

a distance calculation module, configured to calculate distances between an unknown node and at least three known nodes based on a signal propagation loss formula;

an overlapping region calculation module, configured to obtain at least three square regions around the at least three known nodes by using the distances as radiuses, and obtain a minimum overlapping region based on overlapping parts of the at least three square regions;

a region reduction module, configured to reduce the minimum overlapping region in an equal proportion by using a geometric center of the minimum overlapping region as a center to obtain a new square region;

a vertex location calculation module, configured to calculate an optimal vertex location of the new square region through iteration according to an iterative least square method; and

a smaller-region calculation module, configured to form a new smaller region around the optimal vertex location by using the optimal vertex location as a new central point, and use an optimal vertex location of the smaller region as an estimated location of the unknown node.

The technical solution in this embodiment of this application further includes: that the distance calculation module is configured to calculate distances between an unknown node and at least three known nodes based on a signal propagation loss formula is specifically as follows:

$${P}_{L} ( d ) = {P}_{L} ( {d}_{0} ) + 10 n lg ( \frac{d}{{d}_{0}} ) + {X}_{0} ,$$

where

in the formula, d represents a distance between a transmit end and a receive end, d₀ represents a near-earth reference distance, P_{L}O represents a path loss from the transmit end to the distance d, n represents a path loss index, and X₀ represents Gaussian distribution noise whose average value is zero.

The technical solution in this embodiment of this application further includes: that the overlapping region calculation module is configured to obtain at least three square regions around the at least three known nodes by using the distances as radiuses, and obtain a minimum overlapping region based on overlapping parts of the at least three square regions is specifically as follows:

A is defined as a node that makes {zⱼ^{x}+dⱼ}ⱼ₌₁^{N} smallest, in other words,) (z_{A}^{x}, d_{A})=argmin {zⱼ^{x}+dⱼ}_{j<1}^{N}, and A, B, C, and D are defined as follows:

$$\{ \begin{matrix}A \text{:} ( {z}_{A}^{x} , {d}_{A} ) = argmin {\{ {z}_{j}^{x} + {d}_{j} \}}_{j = 1}^{N} \\ B \text{:} ( {z}_{B}^{x} , {d}_{B} ) = argmax {\{ {z}_{j}^{x} - {d}_{j} \}}_{j = 1}^{N} \\ C \text{:} ( {z}_{C}^{y} , {d}_{C} ) = argmin {\{ {z}_{j}^{y} + {d}_{j} \}}_{j = 1}^{N} \\ D \text{:} ( {z}_{D}^{y} , {d}_{D} ) = argmax {\{ {z}_{j}^{y} - {d}_{j} \}}_{j = 1}^{N}\end{matrix} ,$$

where

A, B, C, and D are four vertexes of the minimum overlapping region.

The technical solution in this embodiment of this application further includes an iteration module, and the iteration module is configured to perform iteration to calculate the optimal vertex location of the new smaller region, determine whether a specified quantity of iterations is reached, and use an optimal vertex location in the last iteration process as the estimated location of the unknown node if the specified quantity of iterations is reached.

The technical solution in this embodiment of this application further includes: the new smaller region has a same size as the square region.

Still another technical solution in an embodiment of this application is an electronic device, including:

at least one processor; and

a memory, communicatively connected to the at least one processor, where

the memory stores an instruction executable by the at least one processor, and when the instruction is executed by the at least one processor, the at least one processor is enabled to perform the following operations in the foregoing indoor positioning method:

step a: calculating distances between an unknown node and at least three known nodes based on a signal propagation loss formula;

step b: obtaining at least three square regions around the at least three known nodes by using the distances as radiuses, and obtaining a minimum overlapping region based on overlapping parts of the at least three square regions;

step c: reducing the minimum overlapping region in an equal proportion by using a geometric center of the minimum overlapping region as a center to obtain a new square region;

step d: calculating an optimal vertex location of the new square region through iteration according to an iterative least square method; and

step e: forming a new smaller region around the optimal vertex location by using the optimal vertex location as a new central point, and using an optimal vertex location of the smaller region as an estimated location of the unknown node.

Relative to the prior art, beneficial effects generated in the embodiments of this application are as follows: According to the indoor positioning method and system and the electronic device in the embodiments of this application, an I-Min-Max positioning algorithm that can effectively cope with an external noise change is provided. This range-based algorithm estimates a location of an unknown node by using a least square positioning algorithm with a finite quantity of iterations. The positioning algorithm is less complex, and has a shorter operation time, and therefore can improve positioning precision without increasing a calculation amount, thereby ensuring indoor location positioning accuracy, and featuring strong robustness and algorithm simplicity. In addition, the I-Min-Max positioning algorithm has relatively strong robustness and a high immunity to interference in a case of noise.

### BRIEF DESCRIPTION OF DRAWINGS

FIG. 1 is a schematic diagram of a Min-Max positioning algorithm;

FIG. 2 is a flowchart of an indoor positioning method according to an embodiment of this application;

FIG. 3 is a schematic structural diagram of an indoor positioning system according to an embodiment of this application;

FIG. 4 and FIG. 5 are respectively a schematic diagram of comparison of root mean square errors of different algorithms in cases of different signal to noise ratios and a schematic diagram of comparison of root mean square errors of different algorithms in cases of different quantities of known nodes in an indoor environment;

FIG. 6 is a schematic diagram of comparison of estimation errors of three algorithms, namely, an I-Min-Max algorithm, a Min-Max algorithm, and an E-Min-Max algorithm, in five cases: there are more pedestrians around, there are fewer pedestrians around, there are only testers around, there are fewer obstacles around, and there are more obstacles around; and

FIG. 7 is a schematic structural diagram of a hardware device for an indoor positioning method according to an embodiment of this application.

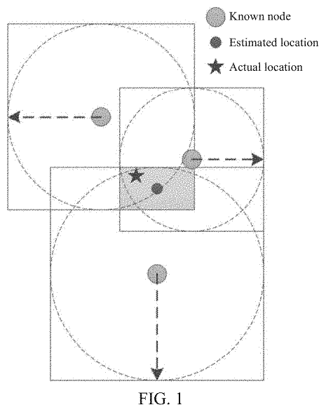

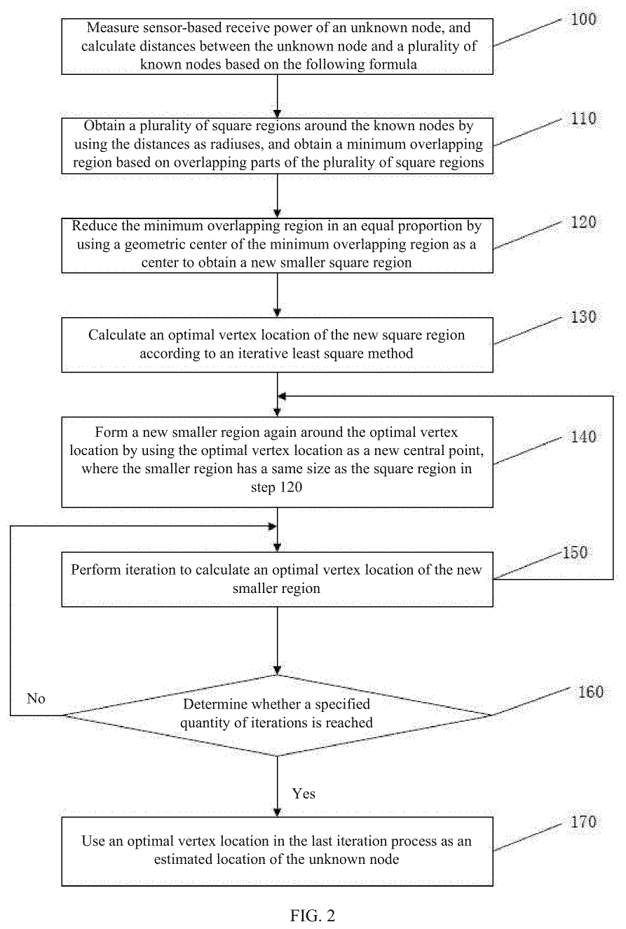

### DESCRIPTION OF EMBODIMENTS

To make the objectives, technical solutions, and advantages of this application clearer, the following further describes this application in detail with reference to the accompanying drawings and embodiments. It should be understood that the specific embodiments described herein are merely intended to describe but not limit this application.

For an indoor positioning problem in a complex indoor environment, this application provides an I-Min-Max positioning algorithm that can effectively cope with an external noise change, to ensure positioning accuracy while guaranteeing a relatively low delay, This range-based algorithm estimates a location of an unknown node, to effectively improve positioning precision without increasing a calculation amount.

Considering that in a two-dimensional spatial range, transmit power of a known node is known and a coordinate point is denoted as Zⱼ=[zⱼ^{x}, zⱼ^{y}], an unknown node is denoted as P=(p^{x}, p^{y}), and distances between the unknown node and known nodes are denoted as d₁, d₂, d₃, . . . , and dₙ, an indoor positioning method in an embodiment of this application is shown in 2. The indoor positioning method in this embodiment of this application specifically includes the following steps:

Step 100: Measure sensor-based receive power of an unknown node, and calculate distances between the unknown node and at least three known nodes based on the following formula:

$${P}_{L} ( d ) = {P}_{L} ( {d}_{0} ) + 10 n lg ( \frac{d}{{d}_{0}} ) + {X}_{0} , \qquad ( 3 )$$

where

d represents a distance (in) between a transmit end and a receive end, d₀ represents a near-earth reference distance, and is usually 1 m, P_{L}(d) represents a path loss from the transmit end to the distance d, n represents a path loss index, and is an environment-related value, and X₀ represents Gaussian distribution noise whose average value is zero in a unit of dB. An approximate distance between a node at the receive end and a node at the transmit end can be calculated by measuring received signal strength and by using the formula (3).

Step 110: Obtain at least three square regions around the known nodes by using the distances as radiuses, and obtain a minimum overlapping region based on overlapping parts of the at least three square regions.

In step 110, A is defined as a node that makes {zⱼ^{x}+dⱼ}ⱼ₌₁^{N} smallest, in other words, (z_{A}^{x}, d_{A})=argmin {zⱼ^{x}+dⱼ}ⱼ₌₁^{N}, and A, B, C, and D are defined as follows:

$$\{ \begin{matrix}A \text{:} ( {z}_{A}^{x} , {d}_{A} ) = argmin {\{ {z}_{j}^{x} + {d}_{j} \}}_{j = 1}^{N} \\ B \text{:} ( {z}_{B}^{x} , {d}_{B} ) = argmax {\{ {z}_{j}^{x} - {d}_{j} \}}_{j = 1}^{N} \\ C \text{:} ( {z}_{C}^{y} , {d}_{C} ) = argmin {\{ {z}_{j}^{y} + {d}_{j} \}}_{j = 1}^{N} \\ D \text{:} ( {z}_{D}^{y} , {d}_{D} ) = argmax {\{ {z}_{j}^{y} - {d}_{j} \}}_{j = 1}^{N}\end{matrix} , \qquad ( 4 )$$

where

A, B, C, and D are four vertexes of the minimum overlapping region.

Step 120: Reduce the minimum overlapping region in an equal proportion by using a geometric center of the minimum overlapping region as a center to obtain a new smaller square region.

In step 120, a reduction proportion coefficient for the reduction in the equal proportion is ω, and a value of ω is equal to 0.5 in this embodiment of this application. The value of ω may be specifically set based on an actual operation. Coordinates of four vertexes of the new square region are νₑ¹=(νₘᵢₙ^{x}^{ₑ}, νₘᵢₙ^{y}^{ₑ}), νₑ²=(νₘᵢₙ^{x}^{ₑ}, νₘₐₓ^{y}^{ₑ}), νₑ³=(νₘₐₓ^{x}^{ₑ}, νₘᵢₙ^{y}^{ₑ}), and νₑ⁴=(νₘₐₓ^{x}^{ₑ}, νₘₐₓ^{y}^{ₑ}), where e represents a quantity of iterations, and 1, 2, 3, and 4 represent the four vertexes of the new square region.

Step 130: Calculate an optimal vertex location of the new square region according to an iterative least square method, where the optimal vertex location is as follows:

$${v}_{e + 1} = {min}_{{v}^{α}} {\sum }_{e = 1}^{n} {( \sqrt{{( {z}_{e}^{x} - {v}_{e}^{α} )}^{2} + {( {z}_{e}^{y} - {v}_{e}^{α} )}^{2}} - {r}_{e} )}^{2} \qquad ( 5 )$$

Step 140: Form a new smaller region around the optimal vertex location by using the optimal vertex location as a new central point, where the smaller region has a same size as the square region in step 120.

Step 150: Perform iteration to calculate an optimal vertex location of the new smaller region, and perform step 140 again.

Step 160: Determine whether a specified quantity of iterations is reached, and perform step 170 if the specified quantity of iterations is reached, otherwise, proceed to step 150.

In step 160, the quantity e of iterations is set to 3 in this embodiment of this application. The quantity e may be specifically set based on an actual operation. It is verified by experiment that a relatively small quantity of iterations can reduce a positioning error. Therefore, in this application, positioning accuracy can be improved without increasing a calculation amount, and there is strong resistance to noise.

Step 170: Use an optimal vertex location in the last iteration process as an estimated location of the unknown node.

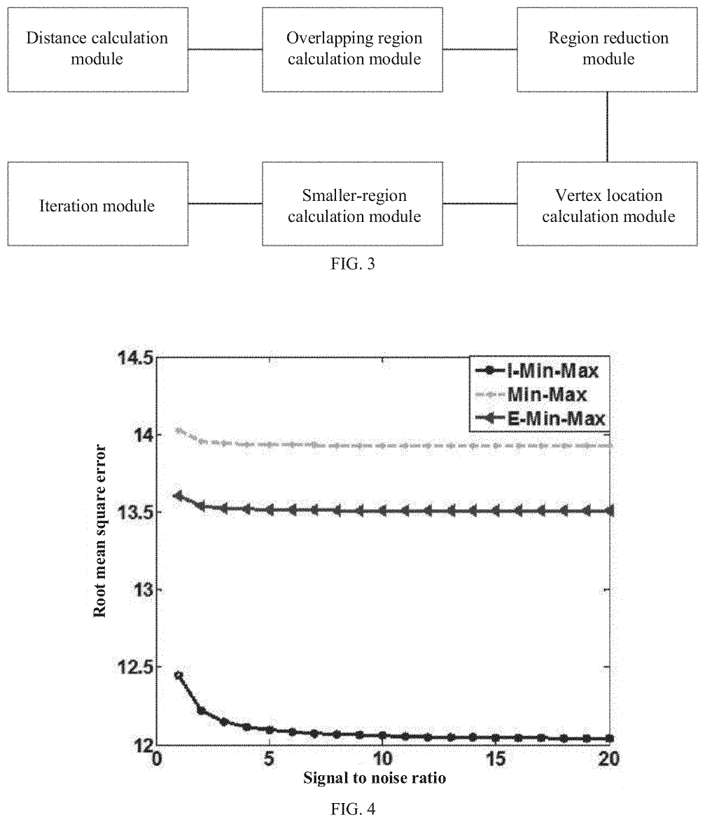

FIG. 3 is a schematic structural diagram of an indoor positioning system according to an embodiment of this application. The indoor positioning system in this embodiment of this application includes a distance calculation module, an overlapping region calculation module, a region reduction module, a vertex location calculation module, a smaller-region calculation module, and an iteration module.

The distance calculation module is configured to measure sensor-based receive power of an unknown node, and calculate distances between the unknown node and at least three known nodes based on the following formula:

$${P}_{L} ( d ) = {P}_{L} ( {d}_{0} ) + 10 n lg ( \frac{d}{{d}_{0}} ) + {X}_{0} , \qquad ( 3 )$$

where

in the formula, d represents a distance (m) between a transmit end and a receive end, d₀ represents a near-earth reference distance, and is usually 1 m, P_{L}(d) represents a path loss from the transmit end to the distance d, n represents a path loss index, and is an environment-related value, and X₀ represents Gaussian distribution noise whose average value is zero in a unit of dB. An approximate distance between a node at the receive end and a node at the transmit end can be calculated by measuring received signal strength and by using the formula (3).

The overlapping region calculation module is configured to obtain at least three square regions around the known nodes by using the distances as radiuses, and obtain a minimum overlapping region based on overlapping parts of the at least three square regions, where A is defined as a node that makes {zⱼ^{x}+dⱼ}ⱼ₌₁^{N} smallest, in other words, (z_{A}^{x}, d_{A})=argmin {zⱼ^{x}+dⱼ}ⱼ₌₁^{N} and A, B, C, and D are defined as follows:

$$\{ \begin{matrix}A \text{:} ( {z}_{A}^{x} , {d}_{A} ) = argmin {\{ {z}_{j}^{x} + {d}_{j} \}}_{j = 1}^{N} \\ B \text{:} ( {z}_{B}^{x} , {d}_{B} ) = argmax {\{ {z}_{j}^{x} - {d}_{j} \}}_{j = 1}^{N} \\ C \text{:} ( {z}_{C}^{y} , {d}_{C} ) = argmin {\{ {z}_{j}^{y} + {d}_{j} \}}_{j = 1}^{N} \\ D \text{:} ( {z}_{D}^{y} , {d}_{D} ) = argmax {\{ {z}_{j}^{y} - {d}_{j} \}}_{j = 1}^{N}\end{matrix} , \qquad ( 4 )$$

where

A, B, C, and D are four vertexes of the minimum overlapping region.

The region reduction module is configured to reduce the minimum overlapping region in an equal proportion by using a geometric center of the minimum overlapping region as a center to obtain a new smaller square region. A reduction proportion coefficient for the reduction in the equal proportion is ω, and a value of ω is equal to 0.5 in this embodiment of this application. The value of ω may be specifically set based on an actual operation. Coordinates of four vertexes of the new square region are νₑ¹=(νₘᵢₙ^{x}^{ₑ}, νₘᵢₙ^{y}^{ₑ}), νₑ²=(νₘᵢₙ^{x}^{ₑ}, νₘₐₓ^{y}^{ₑ}), νₑ³=(νₘₐₓ^{x}^{ₑ}, νₘᵢₙ^{y}^{ₑ}), and νₑ⁴=(νₘₐₓ^{x}^{ₑ}, νₘₐₓ^{y}^{ₑ}), where e represents a quantity of iterations, and 1 and 4 represent the four vertexes of the new square region.

The vertex location calculation module is configured to calculate an optimal vertex location of the new square region according to an iterative least square method, where the optimal vertex location is as follows:

$${v}_{e + 1} = {min}_{{v}^{α}} {\sum }_{e = 1}^{n} {( \sqrt{{( {z}_{e}^{x} - {v}_{e}^{α} )}^{2} + {( {z}_{e}^{y} - {v}_{e}^{α} )}^{2}} - {r}_{e} )}^{2} \qquad ( 5 )$$

The smaller-region calculation module is configured to form a new smaller region around the optimal vertex location by using the optimal vertex location as a new central point. The smaller region has a same size as the square region obtained by the region reduction module.

The iteration module is configured to perform, based on a specified quantity of iterations, iteration to calculate an optimal vertex location of the new smaller region, and use an optimal vertex location in the last iteration process as an estimated location of the unknown node if the specified quantity of iterations is reached. The quantity e of iterations is set to 3 in this embodiment of this application. The quantity e may be specifically set based on an actual operation. It is verified from experiments that a relatively small quantity of iterations can reduce a positioning error. Therefore, in this application, positioning accuracy can be improved without increasing a calculation amount, and there is strong resistance to noise.

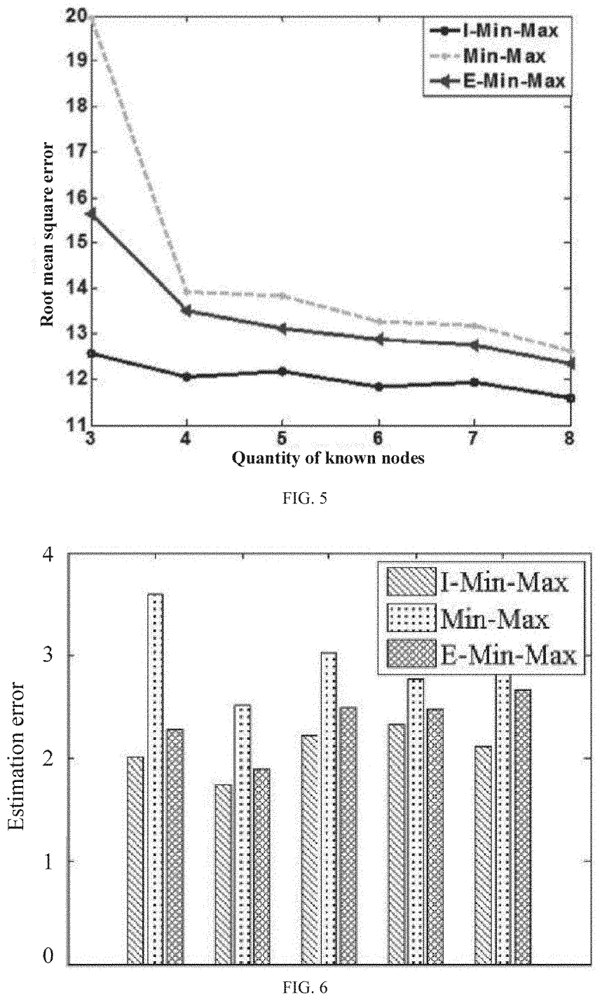

Reliability and validity of the algorithm in this application are verified by experiment and simulation. In experimental verification, a Bluetooth node is used as a known node, a distance between the known node and an unknown node is calculated based on transmit power of the Bluetooth node and the signal propagation loss formula (1), and then positioning is performed by using an I-Min-Max positioning algorithm. It may be understood that the I-Min-Max positioning algorithm in this application is also applicable to another range-based positioning technology such as a Wi-Fi positioning technology. Verification results are shown in FIG. 4 and FIG. 5. FIG. 4 and FIG. 5 are respectively a schematic diagram of comparison of root mean square errors of different algorithms in cases of different signal to noise ratios and a schematic diagram of comparison of root mean square errors of different algorithms in cases of different quantities of known nodes in an indoor environment. It can be learned from the verification results that the I-Min-Max algorithm has a smaller deviation in both cases of different noise environments and different quantities of known nodes, which proves that the -Max positioning algorithm has a smaller error. FIG. 6 is a schematic diagram of comparison of estimation errors of three algorithms, namely, an I-Min-Max algorithm, a Min-Max algorithm, and an E-Min-Max algorithm, in five cases: there are more pedestrians around, there are fewer pedestrians around, there are only testers around, there are fewer obstacles around, and there are more obstacles around. This figure can indicate that the I-Min-Max positioning algorithm provided in this application has higher algorithm performance in different scenarios, and has stronger robustness.

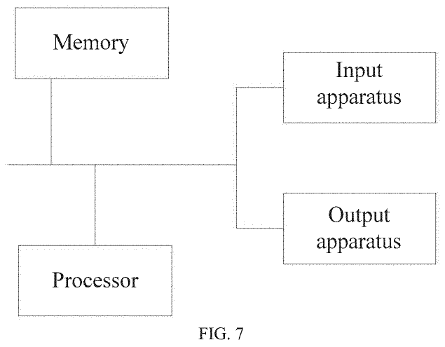

FIG. 7 is a schematic structural diagram of a hardware device for an indoor positioning method according to an embodiment of this application. As shown in FIG. 7, the device includes one or more processors and a memory. One processor is used as an example. The device may further include an input system and an output system.

The processor, the memory, the input system, and the output system may be connected by using a bus or in another manner. In FIG. 7, a bus connection is used as an example.

As a non-transient computer readable storage medium, the memory can be configured to store a non-transient software program, a non-transient computer executable program, and a module. By running the non-transient software program, an instruction, and the module stored in the memory, the processor executes various function applications of an electronic device and performs data processing, in other words, implements the processing method in the foregoing method embodiment.

The memory may include a program storage area and a data storage area. The program storage area may store an operating system and an application program required by at least one function. The data storage area may store data and the like. In addition, the memory may include a high-speed random access memory, and may further include a non-transient memory such as at least one magnetic disk storage device, a flash storage device, or another nontransient solid-state storage device. In some embodiments, optionally, the memory may include a memory that is remotely disposed relative to the processor. The remote memory may be connected to a processing system over a network. Examples of the network include but are not limited to the Internet, an enterprise intranet, a local area network, a mobile communications network, and a combination thereof.

The input system m ay receive input digit or character information, and generate signal input. The output system may include a display device such as a display.

The one or more modules are stored in the memory, and when the one or more modules are executed by the one or more processors, the following operations in any of the foregoing method embodiments are performed:

step a: calculating distances between an unknown node and at least three known nodes based on a signal propagation loss formula;

step b: obtaining at least three square regions around the at least three known nodes by using the distances as radiuses, and obtaining a minimum overlapping region based on overlapping parts of the at least three square regions;

step c: reducing the minimum overlapping region in an equal proportion by using a geometric center of the minimum overlapping region as a center to obtain a new square region;

step d: calculating an optimal vertex location of the new square region through iteration according to an iterative least square method; and

step e: forming a new smaller region around the optimal vertex location by using the optimal vertex location as a new central point, and using an optimal vertex location of the smaller region as an estimated location of the unknown node.

The foregoing product can perform the method provided in the embodiments of this application, has corresponding function modules for performing the method, and can achieve beneficial effects. For technical details that are not described in detail in this embodiment, refer to the method provided in the embodiments of this application.

An embodiment of this application provides a non-transient (nonvolatile) computer storage medium. The computer storage medium stores a computer executable instruction, and the computer executable instruction can be used to perform the following operations:

step a: calculating distances between an unknown node and at least three known nodes based on a signal propagation loss formula;

step b: obtaining at least three square regions around the at least three known nodes by using the distances as radiuses, and obtaining a minimum overlapping region based on overlapping parts of the at least three square regions;

step c: reducing the minimum overlapping region in an equal proportion by using a geometric center of the minimum overlapping region as a center to obtain a new square region;

step d: calculating an optimal vertex location of the new square region through iteration according to an iterative least square method; and

step e: forming a new smaller region around the optimal vertex location by using the optimal vertex location as a new central point, and using an optimal vertex location of the smaller region as an estimated location of the unknown node.

An embodiment of this application provides a computer program product. The computer program product includes a computer program stored in a non-transient computer readable storage medium, the computer program includes a program instruction, and when the program instruction is executed by a computer, the computer is enabled to perform the following operations:

step a: calculating distances between an unknown node and at least three known nodes based on a signal propagation loss formula;

step b: obtaining at least three square regions around the at least three known nodes by using the distances as radiuses, and obtaining a minimum overlapping region based on overlapping parts of the at least three square regions;

step c: reducing the minimum overlapping region in an equal proportion by using a geometric center of the minimum overlapping region as a center to obtain a new square region;

step d: calculating an optimal vertex location of the new square region through iteration according to an iterative least square method; and

step e: forming a new smaller region around the optimal vertex location by using the optimal vertex location as a new central point, and using an optimal vertex location of the smaller region as an estimated location of the unknown node.

According to the indoor positioning method and system and the electronic device in the embodiments of this application, an I-Min-Max positioning algorithm that can effectively cope with an external noise change is provided. This range-based algorithm estimates a location of an unknown node by using a least square positioning algorithm with a finite quantity of iterations. The positioning algorithm is less complex, and has a shorter operation time, and therefore can improve positioning precision without increasing a calculation amount, thereby ensuring indoor location positioning accuracy, and featuring strong robustness and algorithm simplicity. In addition, the I-Min-Max positioning algorithm has relatively strong robustness and a high immunity to interference in a case of noise.

The foregoing description of the disclosed embodiments enables a person skilled in the art to implement or use this application. Various modifications made to these embodiments are apparent to a person skilled in the art, and the general principle defined in this application may be implemented in another embodiment without departing from the spirit or scope of this application. Therefore, this application is not limited to these embodiments shown in this application, but needs to conform to the maximum scope consistent with the principles and novel features disclosed in this application.

1. An indoor positioning method, comprising the following steps:
step a: calculating distances between an unknown node and at least three known nodes based on a signal propagation loss formula;
step b: obtaining at least three square regions around the at least three known nodes by using the distances as radiuses, and obtaining a minimum overlapping region based on overlapping parts of the at least three square regions;
step c: reducing the minimum overlapping region in an equal proportion by using a geometric center of the minimum overlapping region as a center to obtain a new square region;
step d: calculating an optimal vertex location of the new square region through iteration according to an iterative least square method; and
step e: forming a new smaller region around the optimal vertex location by using the optimal vertex location as a new central point, and using an optimal vertex location of the smaller region as an estimated location of the unknown node.

2. The indoor positioning method according to claim 1, wherein the calculating distances between an unknown node and at least three known nodes based on a signal propagation loss formula in step a is specifically as follows:
$${P}_{L} ( d ) = {P}_{L} ( {d}_{0} ) + 10 n lg ( \frac{d}{{d}_{0}} ) + {X}_{0} ,$$
wherein
in the formula, d represents a distance between a transmit end and a receive end, d₀ represents a near-earth reference distance, P_{L}(d) represents a path loss from the transmit end to the distance d, n represents a path loss index, and X₀ represents Gaussian distribution noise whose average value is zero.

3. The indoor positioning method according to claim 2, wherein the obtaining at least three square regions around the at least three known nodes by using the distances as radiuses, and obtaining a minimum overlapping region based on overlapping parts of the at least three square regions in step b is specifically as follows:
A is defined as a node that makes {zⱼ^{x}+dⱼ}ⱼ₌₁^{N} smallest, in other words, (zₐ^{x}, d_{A})=argmin {zⱼ^{x}+dⱼ}ⱼ₌₁^{N}, and A, B, C, and D are defined as follows:
$$\{ \begin{matrix}A \text{:} ( {z}_{A}^{x} , {d}_{A} ) = argmin {\{ {z}_{j}^{x} + {d}_{j} \}}_{j = 1}^{N} \\ B \text{:} ( {z}_{B}^{x} , {d}_{B} ) = argmax {\{ {z}_{j}^{x} - {d}_{j} \}}_{j = 1}^{N} \\ C \text{:} ( {z}_{C}^{y} , {d}_{C} ) = argmin {\{ {z}_{j}^{y} + {d}_{j} \}}_{j = 1}^{N} \\ D \text{:} ( {z}_{D}^{y} , {d}_{D} ) = argmax {\{ {z}_{j}^{y} - {d}_{j} \}}_{j = 1}^{N}\end{matrix} ,$$
where
A, B, C, and D are four vertexes of the minimum overlapping region.

4. The indoor positioning method according to claim 3, wherein the forming a new smaller region around the optimal vertex location by using the optimal vertex location as a new central point, and using an optimal vertex location of the smaller region as an estimated location of the unknown node in step e specifically comprises: performing iteration to calculate the optimal vertex location of the new smaller region, determining whether a specified quantity of iterations is reached, and using an optimal vertex location in the last iteration process as the estimated location of the unknown node if the specified quantity of iterations is reached.

5. The indoor positioning method according to claim 4, wherein in step e, the new smaller region has a same size as the square region.

6. An indoor positioning system, comprising:
a distance calculation module, configured to calculate distances between an unknown node and at least three known nodes based on a signal propagation loss formula;
an overlapping region calculation module, configured to obtain at least three square regions around the at least three known nodes by using the distances as radiuses, and obtain a minimum overlapping region based on overlapping parts of the at least three square regions;
a region reduction module, configured to reduce the minimum overlapping region in an equal proportion by using a geometric center of the minimum overlapping region as a center to obtain a new square region;
a vertex location calculation module, configured to calculate an optimal vertex location of the new square region through iteration according to an iterative least square method; and
a smaller-region calculation module, configured to form a new smaller region around the optimal vertex location by using the optimal vertex location as a new central point, and use an optimal vertex location of the smaller region as an estimated location of the unknown node.

7. The indoor positioning system according to claim 6, wherein that the distance calculation module is configured to calculate distances between an unknown node and at least three known nodes based on a signal propagation loss formula is specifically as follows:
$${P}_{L} ( d ) = {P}_{L} ( {d}_{0} ) + 10 n lg ( \frac{d}{{d}_{0}} ) + {X}_{0} ,$$
wherein
in the formula, d represents a distance between a transmit end and a receive end, d₀ represents a near-earth reference distance, P_{L}(d) represents a path loss from the transmit end to the distance d, n represents a path loss index, and X₀ represents Gaussian distribution noise whose average value is zero.

8. The indoor positioning system according to claim 7, wherein that the overlapping region calculation module is configured to obtain at least three square regions around the at least three known nodes by using the distances as radiuses, and obtain a minimum overlapping region based on overlapping parts of the at least three square regions is specifically as follows:
A is defined as a node that makes {zⱼ^{x}+dⱼ}ⱼ₌₁^{N} smallest, in other words, (z_{A}^{x}, d_{A})=argmin {zⱼ^{x}+dⱼ}ⱼ₌₁^{N}, and A, B, C, and D are defined as follows:
$$\{ \begin{matrix}A \text{:} ( {z}_{A}^{x} , {d}_{A} ) = argmin {\{ {z}_{j}^{x} + {d}_{j} \}}_{j = 1}^{N} \\ B \text{:} ( {z}_{B}^{x} , {d}_{B} ) = argmax {\{ {z}_{j}^{x} - {d}_{j} \}}_{j = 1}^{N} \\ C \text{:} ( {z}_{C}^{y} , {d}_{C} ) = argmin {\{ {z}_{j}^{y} + {d}_{j} \}}_{j = 1}^{N} \\ D \text{:} ( {z}_{D}^{y} , {d}_{D} ) = argmax {\{ {z}_{j}^{y} - {d}_{j} \}}_{j = 1}^{N}\end{matrix} ,$$
wherein
A, B, C, and D are four vertexes of the minimum overlapping region.

9. The indoor positioning system according to claim 8, further comprising an iteration module, wherein the iteration module is configured to perform iteration to calculate the optimal vertex location of the new smaller region, determine whether a specified quantity of iterations is reached, and use an optimal vertex location in the last iteration process as the estimated location of the unknown node if the specified quantity of iterations is reached.

10. The indoor positioning system according to claim 9, wherein the new smaller region has a same size as the square region.

11. An electronic device comprising:
at least one processor; and
a memory, communicatively connected to the at least one processor, wherein the memory stores an instruction executable by the at least one processor, and when the instruction is executed by the at least one processor, the at least one processor is enabled to perform the following operations in the indoor positioning method according to claim 1:
step a: calculating distances between an unknown node and at least three known nodes based on a signal propagation loss formula;
step b: obtaining at least three square regions around the at least three known nodes by using the distances as radiuses, and obtaining a minimum overlapping region based on overlapping parts of the at least three square regions;
step c: reducing the minimum overlapping region in an equal proportion by using a geometric center of the minimum overlapping region as a center to obtain a new square region;
step d: calculating an optimal vertex location of the new square region through iteration according to an iterative least square method; and
step e: forming a new smaller region around the optimal vertex location by using the optimal vertex location as a new central point, and using an optimal vertex location of the smaller region as an estimated location of the unknown node.
